(19) United States
(12) Patent Application Publication
(10) Pub. No.: US 2026/0196708 A1
(43) Pub. Date: Jul. 9, 2026

(54) ANTENNA APPARATUS FOR IMPROVED BEAMFORMING AND EFFICIENCY IN ELECTRONIC APPARATUS

(71) Applicants: Samsung Electronics Co., Ltd., Gyeonggi-do (KR); Seoul National University R&DB Foundation, Seoul (KR)

(72) Inventors: Jungi JEONG, Gyeonggi-do (KR); Jungsuek OH, Seoul (KR); Seungwoo BANG, Seoul (KR); Jaehoon KIM, Seoul (KR); Junhwa OH, Gyeonggi-do (KR)

(21) Appl. No.: 19/437,760

(22) Filed: Dec. 31, 2025

(30) Foreign Application Priority Data
Jan. 3, 2025 (KR) 10-2025-0000636

(51) Int. Cl. H01Q 1/22; H01Q 9/04

(52) U.S. Cl. CPC H01Q 1/22; H01Q 9/0414

(57) ABSTRACT

Disclosed are an antenna apparatus and an electronic apparatus including the antenna apparatus in a wireless communication system. The antenna apparatus includes an antenna structure including a plurality of radiators, a transmission line, and a slot, wherein the antenna structure includes a first radiator, a second radiator, and a third radiator, wherein the first radiator and the second radiator are arranged in parallel in a direction parallel to the transmission line, and wherein the third radiator are arranged opposite the first radiator and the second radiator with respect to the transmission line to be arranged in a triangular form.

### CROSS-REFERENCE TO RELATED APPLICATION(S)

This application is based on and claims priority under 35 U.S.C. § 119 to Korean Patent Application No. 10-2025-0000636, filed on Jan. 3, 2025, in the Korean Intellectual Property Office, the disclosure of which is incorporated herein by reference in its entirety.

### BACKGROUND

### 1. Field

The disclosure relates generally to a wireless communication system, and more particularly, to an antenna apparatus for improved beamforming and efficiency in an electronic apparatus for use in a wireless communication system.

### 2. Description of the Related Art

5th-generation (5G) mobile communication technology defines a wide frequency band to allow high transmission speed and new service and may also be implemented in an ultra-high frequency above 6 gigahertz (GHz) band referred to as millimeter wave (mmWave) band, such as 28 GHz and 39 GHz bands, as well as a below 6 GHz frequency (sub 6 GHZ) band such as a 3.5 GHz band. In the 6th-generation (6G) mobile communication technology referred to as the beyond 5G system, implementation in the terahertz (THz) band (e.g., 95 GHz to 3 THz band) is being considered to achieve a transmission speed that is 50 times the transmission speed of the 5G mobile communication technology and an ultra-low delay time that is one tenth of the delay time of the 5G mobile communication technology.

Since the early stages of the 5G mobile communication technology, to support services and satisfy performance requirements for enhanced mobile broadband (eMBB), ultra-reliable low-latency communications (URLLC), and massive machine-type communications (mMTC), standardization has been performed on beamforming and massive multiple input multiple output (MIMO) for mitigating the path loss of radio waves in the ultra-high frequency band and increasing the propagation distance of radio waves, support of various numerologies (operation of multiple subcarrier intervals and the like) and dynamic operation of slot formats for efficient utilization of ultra-high frequency resources, initial access technology for supporting multi-beam transmission and broadband, definition and operation of bandwidth parts (BWPs), new channel coding methods such as low-density parity check (LDPC) codes for large-capacity data transmission and polar codes for reliable transmission of control information, layer 2 (L2) preprocessing, network slicing for providing dedicated networks specialized for particular services, and the like.

By considering services that the 5G mobile communication technology was intended to support, discussion for initial 5G mobile communication technology improvement and enhancement has been performed, and physical layer standardization for technologies such as vehicle-to-everything (V2X) for assisting the driving determination of autonomous vehicles and increasing the convenience of users based on the position and state information transmitted by the vehicles, new radio unlicensed (NR-U) for system operations meeting various regulation requirements in unlicensed bands, NR terminal low power consumption technology (UE power saving), non-terrestrial network (NTN) that is terminal-satellite direct communication for securing a coverage in an area where communication with a terrestrial network is impossible, and positioning has been performed.

In addition, standardization of wireless interface architectures/protocols for technologies such as industrial Internet of things (IloT) for supporting new services through linkage and integration with other industries, Integrated Access and Backhaul (IAB) for providing nodes for expanding network service areas by integrating a wireless backhaul link and an access link, mobility enhancement including conditional handover and dual active protocol stack (DAPS) handover, and 2-step random access channel (RACH) for NR for simplifying a random access procedure has also been performed, and standardization of system architectures/services for 5G baseline architectures (e.g., service-based architecture and service-based interface) for grafting network function virtualization (NFV) and software-defined networking (SDN) technology, mobile edge computing (MEC) for providing services based on the position of terminals, and the like has also been performed.

When such 5G mobile communication systems are commercialized, connected devices in the trend of continued proliferation will be connected to the communication network. Accordingly, it is expected to require enhanced functions and performance of the 5G mobile communication system and integrated operation of connected devices. For this purpose, new research will be conducted on extended reality (XR) for efficiently supporting augmented reality (AR), virtual reality (VR), mixed reality (MR), and the like, 5G performance improvement and complexity reduction utilizing artificial intelligence (AI) and machine learning (ML), AI service support, metaverse service support, drone communication, and the like.

The development of the 5G mobile communication systems may serve as a basis for the development of not only multi-antenna transmission technologies such as new waveform, full dimensional MIMO (FD-MIMO), array antenna, and large scale antenna for ensuring the coverage in the THz band of the 6G mobile communication technology, high-dimensional spatial multiplexing technologies using metamaterial-based lenses and antennas and orbital Angular momentum (OAM) to improve the coverage of THz band signals, and reconfigurable intelligent surface (RIS) technologies, but also full duplex technologies for improving the frequency efficiency and system network of the 6G mobile communication technology, AI-based communication technologies utilizing satellites and AI from the design stage and embedding an end-to-end AI support function to realize system optimization, next-generation distributed computing technologies for realizing services with complexity beyond the limit of the terminal operation capability by utilizing ultrahigh-performance communication and computing resources, and the like.

### SUMMARY

An aspect of the disclosure is to provide an antenna apparatus and an electronic apparatus for achieving precise beamforming performance while maintaining efficiency compared to an array-type antenna in the conventional art.

In accordance with an aspect of the disclosure, an antenna apparatus may include an antenna structure including a plurality of radiators, a transmission line, and a slot. The antenna structure may include a first radiator, a second radiator, and a third radiator. The first radiator and the second radiator may be arranged in parallel in a direction parallel to the transmission line. The third radiator may be arranged opposite the first radiator and the second radiator with respect to the transmission line to be arranged in a triangular form.

In accordance with an aspect of the disclosure, an electronic apparatus may include an antenna apparatus. The antenna apparatus may include an antenna structure including a plurality of radiators, a transmission line, and a slot. The antenna structure may include a first radiator, a second radiator, and a third radiator. The first radiator and the second radiator may be arranged in parallel in a direction parallel to the transmission line. The third radiator may be arranged opposite the first radiator and the second radiator with respect to the transmission line to be arranged in a triangular form.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a network environment including an electronic apparatus according to an embodiment;

FIG. 2 illustrates a structure of a varactor-based antenna radiator according to an embodiment;

FIG. 3 illustrates a structure of a triangular array-based antenna according to an embodiment;

FIG. 4A illustrates a configuration of a triangular array-based radiator array according to an embodiment;

FIG. 4B illustrates an adjustment of a coupling coefficient based on a slot position according to an embodiment;

FIG. 5 illustrates a stack of an antenna apparatus according to an embodiment;

FIG. 6 illustrates a stack for each transmission line type of an antenna apparatus according to an embodiment;

FIG. 7 illustrates a configuration of a bias line and a ground line according to an embodiment;

FIG. 8 illustrates a layout of antenna radiators according to an embodiment;

FIG. 9 illustrates a graph of a radiation pattern of a triangular array-based radiator according to an embodiment;

FIG. 10 illustrates a shape configuration of a slot according to an embodiment; and

FIG. 11 illustrates a shape configuration of a resonator according to an embodiment.

### DETAILED DESCRIPTION

Hereinafter, embodiments of the disclosure are described in detail with reference to the accompanying drawings. In the drawings, the same or similar elements are preferably denoted by the same or similar reference numerals. Detailed descriptions of known functions or configurations that may cause the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Embodiments of the disclosure enable a constitution of the disclosure to be complete, and are provided to fully inform the scope of the disclosure to those of ordinary skill in the art to which the disclosure pertains.

Like reference numerals refer to like components throughout the specification.

Throughout the disclosure, the expression “at least one of a, b or c” indicates only a, only b, only c, both a and b, both a and c, both b and c, all of a, b, and c, or variations thereof.

Throughout the specification, a layer may also be referred to as an entity.

Those of ordinary skill in the art will understand that the principles of the disclosure may be implemented in any suitably arranged system or apparatus.

The following description given with reference to the accompanying drawings is provided to facilitate a comprehensive understanding of various embodiments of the disclosure.

The singular forms “a”, “an”, and “the” may include plural forms as well, unless otherwise specified.

Thus, for example, a “component surface” may include one or more component surfaces.

The terms “includes” or “may include” specify the presence of stated functions, operations, or components that may be used herein but do not preclude the presence of one or more additional functions, operations, or components.

Terms such as “include” and/or “have” specify the presence of particular features, integers, steps, operations, elements, components, or any combinations thereof but do not preclude the presence or addition of one or more other features, integers, steps, operations, elements, components, or any combinations thereof.

The term “or” used herein may include any or all combinations of the listed items.

For example, the expression “A or B” may include A, B, or both A and B.

Unless otherwise defined, all terms (including technical or scientific terms) used herein may have the same meaning as understood by those of ordinary skill in the art to which the disclosure pertains.

Although terms such as “first” and “second” may be used herein to describe various elements, the elements should not be limited by the terms. These terms are only used to distinguish one element from another element. For example, without departing from the scope of the disclosure, a first element may be referred to as a second element, and vice versa. As used herein, the term “and/or” may include any one or any combination of the associated listed items.

Also, relative terms such as “front”, “rear”, “upper”, and “lower” described based on the illustration in the drawings may be replaced with ordinal numbers such as “first” and “second”. The order of ordinal numbers such as “first” and “second” may be the order stated or randomly determined and may be randomly changed as necessary.

Herein, an electronic apparatus may be any apparatus including a touch panel and may be referred to as a terminal, a portable terminal, a mobile terminal, a communication terminal, a portable communication terminal, a portable mobile terminal, a display apparatus, or the like.

For example, the electronic apparatus may be a smartphone, a mobile phone, a navigation apparatus, a game machine, a television (TV), a vehicle head unit, a notebook computer, a laptop computer, a tablet computer, a personal media player (PMP), or a personal digital assistant (PDA). The electronic apparatus may also be implemented as a pocket-sized portable communication terminal having a wireless communication function, or as a flexible apparatus or a flexible display apparatus.

The electronic apparatus may communicate with an external electronic apparatus such as a server or may perform an operation through linkage with an external electronic apparatus. For example, the electronic apparatus may transmit an image obtained by a camera and/or position information detected by a sensor unit, to a server through a network. The network may be, but is not limited to, a mobile or cellular network, a local area network (LAN), a wireless local area network (WLAN), a wide area network (WAN), the Internet, or a small area network (SAN).

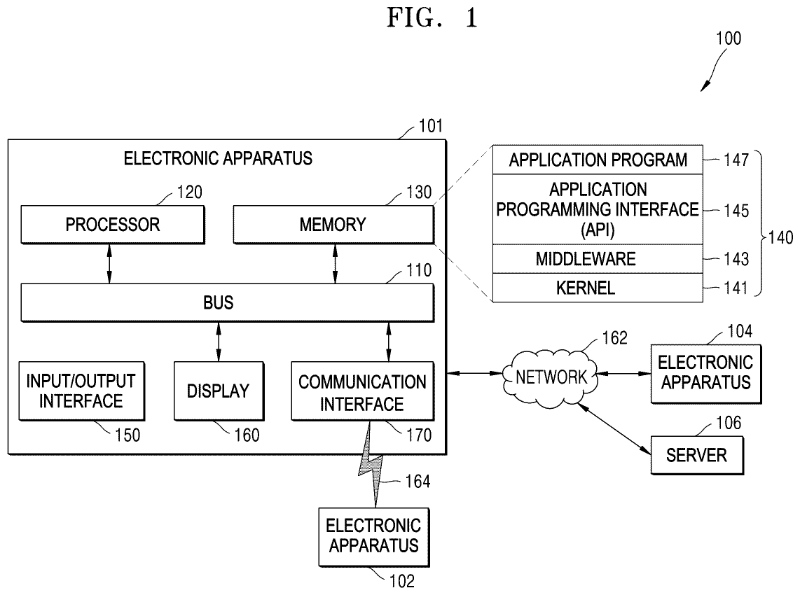

FIG. 1 illustrates a network environment including an electronic apparatus according to an embodiment.

Referring to FIG. 1, an electronic apparatus 101 in a network environment 100 may include a bus 110, a processor 120, a memory 130, an input/output interface 150, a display 160, and a communication interface 170. The electronic apparatus 101 may not include at least one of the above components or may further include one or more additional components.

The bus 110 may include, for example, a circuit for connecting the above components (120 to 170) and transmitting communication information (e.g., control messages and/or data) between the above components.

The processor 120 may include at least one of a central processing unit (CPU), an application processor (AP), or a communication processor (CP). For example, the processor 120 may execute control of one or more other components of the electronic apparatus 101 and/or data processing or operations related to communication.

The memory 130 may include a volatile memory and/or a nonvolatile memory and may store data or commands related to one or more other components of the electronic apparatus 101. The memory 130 may store software and/or a program 140 including, for example, a kernel 141, middleware 143, an application programming interface (API) 145, and/or an application program (or “application”) 147. At least a portion of the kernel 141, the middleware 143, or the API 145 may be referred to as an operating system (OS).

The kernel 141 may control or manage system resources (e.g., the bus 110, the processor 120, or the memory 130) used to execute operations or functions implemented in the middleware 143, the API 145, or the application program 147, and may provide an interface for controlling or managing the system resources when the middleware 143, the API 145, or the application program 147 accesses each component of the electronic apparatus 101.

The middleware 143 may perform a relay function so that the API 145 or the application program 147 may communicate data with the kernel 141.

The middleware 143 may process one or more operation requests received from the application program 147 according to the priority thereof and may give at least one of the application programs 147 the priority to use the system resource (e.g., the bus 110, the processor 120, or the memory 130) of the electronic apparatus 101. The middleware 143 may perform scheduling or load balancing on the one or more operation requests by processing the one or more operation requests according to the given priority.

The API 145 enables the application 147 to control a function provided by the kernel 141 or the middleware 143, and may include at least one interface or function (e.g., instructions) for file control, window control, image processing, or character control.

The input/output interface 150 may function for transmitting a command or data input from the user or another external device to one or more other components of the electronic apparatus 101 and may output a command or data received from one or more other components of the electronic apparatus 101 to the user or another external device.

The display 160 may include, for example, a liquid crystal display (LCD), a light emitting diode (LED) display, an organic light emitting diode (OLED) display, a microelectromechanical system (MEMS) display, or an electronic paper display. The display 160 may display various types of content (e.g., texts, images, videos, icons, or symbols) to the user. The display 160 may include a touch screen and may receive a touch, gesture, proximity, or hovering input by using an electronic pen or a portion of the body of the user.

The communication interface 170 may set the communication between the electronic apparatus 101 and an external apparatus (e.g., a first external electronic apparatus 102, a second external electronic apparatus 104, or a server 106). For example, by wireless communication or wired communication, the communication interface 170 may be connected to a network 162 to communicate with the external apparatus (e.g., the second external electronic apparatus 104 or the server 106).

The wireless communication may use at least one of long-term evolution (LTE), LTE advanced (LTE-A), code division multiple access (CDMA), wideband CDMA (WCDMA), universal mobile telecommunications system (UMTS), wireless broadband (WiBro), or global system for mobile communications (GSM) as cellular communication protocol. The wireless communication may include short-range communication 164 including at least one of wireless fidelity (WiFi), Bluetooth®, near field communication (NFC), or global navigation satellite system ((GNSS) or (Glonass)). The GNSS may include at least one of global positioning system (GPS), Beidou navigation satellite system (Beidou), or Galileo (or the European global satellite-based navigation system) according to regions or bandwidths (BWs). Hereinafter, GPS may be interchangeably used with the term GNSS. The wired communication may include at least one of universal serial bus (USB), high definition multimedia interface (HDMI), recommended standard-232 (RS232), or plain old telephone service (POTS). The network 162 may include at least one of a telecommunications network, a local area network (LAN) or wide area network (WAN)), the Internet, or a telephone network.

Each of the external electronic apparatuses 102 and 104 may be the same as or different from the electronic apparatus 101. The server 106 may include a group of one or more servers. All or some of the operations executed in the electronic apparatus 101 may be executed in one or more of the external electronic apparatuses 102 and 104 or the server 106. When the electronic apparatus 101 needs to perform a function or a service automatically or at the request, the electronic apparatus 101 may request at least some function related thereto from the external electronic apparatuses 102 and 104 or the server 106 in addition to or instead of directly executing the function or the service. The external electronic apparatuses 102 and 104 or the server 106 may execute the requested function or the additional function and transmit the execution results to the electronic apparatus 101. The electronic apparatus 101 may provide the requested function or service by processing the received execution results additionally or without change. For this purpose, cloud computing, distributed computing, or client-server computing technology may be used.

Herein, a conductive member arranged along the edge of an electronic apparatus is described as an example of a conductive member used as an antenna radiator; however, the disclosure is not limited thereto. For example, various metallic structures included in the electronic apparatus may also be used as an antenna radiator. The electronic apparatus may be a bar-type electronic apparatus; however, the disclosure is not limited thereto. The electronic apparatus may be an electronic apparatus with various opening/closing methods or a wearable electronic apparatus.

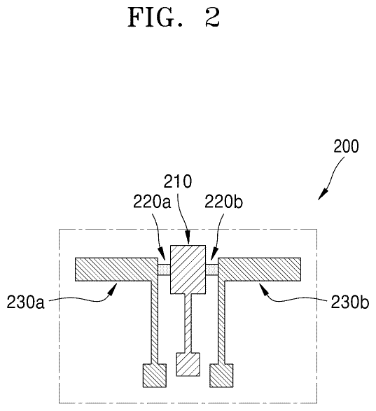

FIG. 2 illustrates a structure of a varactor-based antenna radiator according to an embodiment.

Referring to FIG. 2, the antenna apparatus may include an antenna radiator 200 configured to radiate electromagnetic waves, and the antenna radiator 200 may include a resonator 210 including a plurality of side surfaces that resonate at a particular frequency.

The antenna radiator 200 may include a varactor-based antenna radiator. In a serial feed array antenna in which a plurality of antenna radiators is connected in series to a single transmission line, the current supplied to each radiator should be maximized to satisfy the maximum radiation efficiency condition, and the phase of the current should be the same for all radiators. When a varactor whose capacitance varies depending on the applied bias is arranged in the radiator, the phase compensation of the varactor (e.g., 220a) may reduce the inter-radiator distance of the serial feed array antenna, thus achieving precise beamforming performance while maintaining efficiency compared to an array-type antenna.

The antenna radiator 200 based on the varactor (e.g., 220a) may include a plurality of varactors, which may be connected to the side surface of the resonator 210. For example, the first varactor 220a and the second varactor 220b may be connected to different side surfaces of the resonator 210.

The antenna radiator 200 may include a plurality of pads 230a, 230b. A first pad 230a and a second pad 230b may be connected to each varactor 220a, 220b, and the first pad 230a and the second pad 230b may be connected to different varactors 220a, 220b. In this case, the first pad 230a and the second pad 230b may be connected to the varactor 220a, 220b in a direction parallel to the direction in which the resonator 210 and the varactor 220a, 220b are connected to each other.

In the varactor-based antenna radiator 200, a current may be formed in the longitudinal direction of the resonator 210 and each pad 230a, 230b, and an electromagnetic wave supplied from a single transmission line may be transmitted to free space. The interval between the radiators may be determined as half the wavelength in a tube, based on the frequency at which the antenna operates. The wavelength in the tube may be determined by Equation (1) as follows.

$${λ}_{g} = \frac{c}{f \sqrt{{ε}_{e f f}}} \qquad ( 1 )$$

In Equation (1), λ_{g} is the wavelength in the tube, “c” is the speed of light, “f” is the operation frequency, and ε_{eff} is the effective relative dielectric constant of a substrate into which a transmission line is inserted, which may be determined by the relative dielectric constant of the dielectric substrate and the shape of the transmission line. The operation frequency and optimal array interval of the antenna may be determined according to the length of the resonator 210 and the dielectric constant of the dielectric substrate, and the operation frequency and optimal array interval of the antenna desired by the user may be determined by modifying the length of the resonator 210 and the type of the dielectric substrate.

In the varactor-based antenna radiator 200, when the inter-radiator array interval of the serial feed array antenna is λ_{g}/2, the problem of current phase imbalance in each antenna may be solved through the phase compensation of the varactor.

However, in the varactor-based antenna radiator 200, the phase variation range by the varactors 220a, 220b may be significantly affected by the length of the pads 230a, 230b. As the length of the pads 230a, 230b increase, the phase variation range by the varactors 220a, 220b may increase, and the length of the antenna radiator 200 may also increase.

To secure the phase variation range, the length of the varactor-based antenna radiator 200 may be greater than an antenna array interval λ_{g}/2. In this case, because an overlap between antennas occurs when antenna radiators 200 are simply connected in series, it may be difficult to implement a varactor-based serial feed array antenna.

Thus, the disclosure teaches a triangular array-based varactor antenna structure that may satisfy the highest efficiency condition of a serial feed antenna without an overlap between antenna elements.

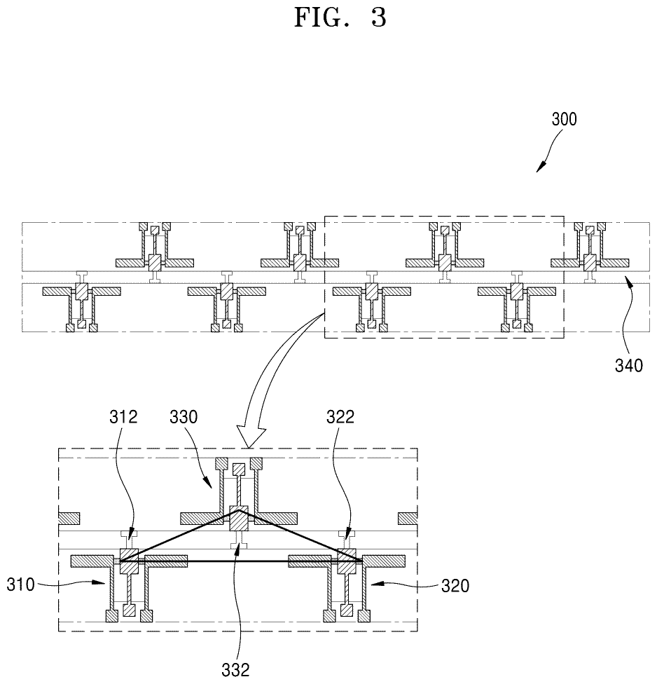

FIG. 3 illustrates a structure of a triangular array-based antenna according to an embodiment.

Referring to FIG. 3, the antenna apparatus 300 may include an antenna structure including a plurality of radiators 310, 320, 330, and the plurality of radiators 310, 320, 330 may be connected in series as a serial feed array antenna. By two-dimensionally extending the antenna array, the plurality of radiators 310, 320, 330 may be connected in series as a plurality of serial feed array antennas, and the plurality of radiators 310, 320, 330 connected as each serial feed array antenna may be arranged in a zigzag form described herein as a triangular array-based form.

The antenna apparatus 300 may include a transmission line 340 and a plurality of slots (e.g., 312, 322, 332). At least a portion of each slot (e.g., 312, 322, 332) may be located between each radiator 310, 320, 330 and the transmission line 340. For example, at least a portion of the each slot (e.g., 312, 322, 332) may connect the antenna structure and the transmission line 340 in a coupling form.

The antenna apparatus 300 may include a first radiator 310 with a slot 312 formed therein, a second radiator 320 arranged in a direction parallel to a transmission line 340 as a serial feed array antenna with the first radiator 310, and a third radiator 330 arranged as a radiator of a separate array antenna that is different from the array antenna in which the first radiator 310 and the second radiator 320 are arranged. The first radiator 310, the second radiator 320, and the third radiator 330 may be arranged in a triangular array form, and the first radiator 310, the second radiator 320, and the third radiator 330 may receive the same current from the same transmission line 340. The transmission line 340 is illustrated as having a structure directly connected to the first radiator 310, the second radiator 320, and the third radiator 330. However, the disclosure is not limited thereto. The first radiator 310 may receive a current by forming a capacitive coupling with the transmission line 340.

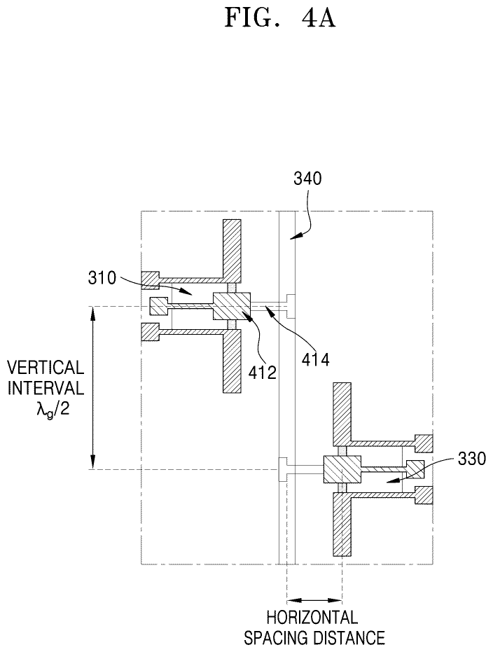

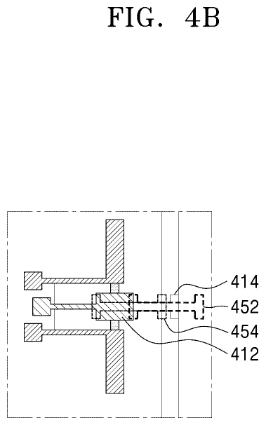

FIG. 4A illustrates a configuration of a triangular array-based radiator array according to an embodiment.

Referring to FIG. 4A, in a varactor-based array antenna, to secure a phase variation range, the length of a varactor-based antenna radiator may be greater than the antenna array interval λ_{g}/2 disclosed herein.

A triangular array-type antenna is disclosed herein since an overlap between antennas occurs when an antenna radiator (e.g., 310) is simply connected to a single serial feed array antenna.

The vertical interval between the radiators (e.g., 310 and 330) may be λ_{g}/2. The interval between the radiators may be between the radiators arranged in a zigzag form in a triangular array, not the interval between the radiators arranged in parallel as the same serial feed array antenna. For example, the interval between the radiators may not be the interval between a first radiator 310 and a second radiator (e.g., 320 in FIG. 3) arranged in a direction parallel to a transmission line 340 as a serial feed array antenna. When there is a third radiator 330 arranged as a radiator of a separate array antenna that is different from an array antenna in which the first radiator 310 and the second radiator (e.g., 320 in FIG. 3) are arranged, the interval between the radiators may be between the first radiator 310 and the third radiator 330 or between the second radiator (e.g., 320 in FIG. 3) and the third radiator 330. The vertical interval may be with respect to an axis parallel to the transmission line 430. In FIG. 4A, only a first radiator 310 and a third radiator 330 are illustrated as an example; however, the disclosure is not limited thereto. Due to the phase variation effect of the varactor, because the phases of the currents supplied to the radiators become equal to each other when the vertical interval between the radiators is λ_{g}/2, the precise beamforming performance of the antenna apparatus may be maximized.

The horizontal radiator spacing distance may be less than λ_{g}/2 and refers to the interval with respect to an axis perpendicular to the transmission line 430. The radiator spacing distance may refer to the distance between the radiator (e.g., 310) and the transmission line 430. For example, when viewed from above the antenna apparatus, the radiator spacing distance may refer to the distance between a transmission line 340 and a first resonator 412 of the first antenna radiator 310.

The horizontal radiator spacing distance may correspond to the length of a slot that connects the transmission line 430 and the radiator in a coupling form. For example, the length of the first slot 414 may be determined such that the first slot 414 may always be located on the first resonator 412 and the transmission line 340. When the length of the first slot 414 increases, more energy should be transmitted from the transmission line 340 to the first resonator 412 and the possibility of breaking the impedance matching may increase. The impedance matching may refer to matching the impedance of the transmission line 340 and the impedance of the first resonator 412 to be equal to each other in a signal transmission path. When the length of the first slot 414 decreases, the length of an electromagnetic wave transmitted from the transmission line 340 through the first slot 414 to the first resonator 412 may be restricted. To maintain the precise beamforming performance, the antenna radiator may be located at a distance of less than λ_{g}/2 from the transmission line 340. For example, the first antenna radiator 310 may be located at a distance of less than λ_{g}/2 from the transmission line 340. Particularly, the horizontal radiator spacing distance may be about 0.4 millimeters (mm) to about 1.5 mm.

FIG. 4B illustrates an adjustment of a coupling coefficient based on a slot position according to an embodiment.

A coupling coefficient representing the degree of energy transmission efficiency transmitted to the resonator may be adjusted by adjusting the position of the slot that connects the antenna structure and the transmission line in a coupling form. For example, when the first slot 414 is located far from the first resonator 412 (e.g., the first location 452), the energy transmission efficiency transmitted to the first resonator 412 may decrease and thus the coupling coefficient may decrease. The coupling coefficient may be adjusted to be reduced by adjusting the position of the slot such that only a portion of the slot is located between the antenna structure and the transmission line. Particularly, the position of the slot may be adjusted such that a portion of the slot is located outside the transmission line while the center of the slot is located between the antenna structure and the transmission line, or the position of the slot may be adjusted such that only a portion of the slot is located between the antenna structure and the transmission line while the center of the slot is located outside the transmission line. By locating the first slot 414 close to the first resonator 412 (e.g., the first location 454), the energy transmission efficiency transmitted to the first resonator 412 may be increased and thus the coupling coefficient may be adjusted to be increased.

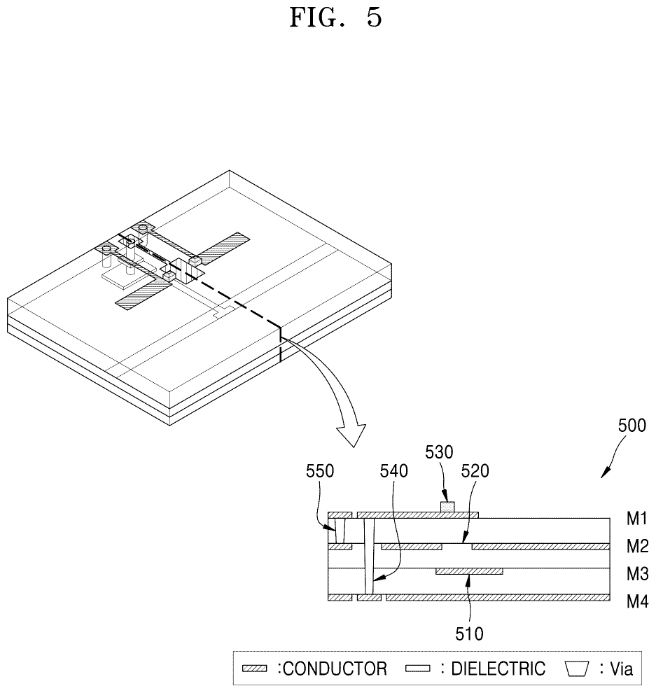

FIG. 5 illustrates a stack of an antenna apparatus according to an embodiment.

Referring to FIG. 5, an antenna apparatus 500 may be implemented by arranging an antenna structure and a transmission line 510 by considering the direction in which a radio wave is to be radiated. In this case, the antenna structure and the transmission line 510 may include a conductive pattern formed on one surface of one of the dielectric layers constituting a multilayer circuit board of the antenna apparatus 500. The conductive pattern may form a layer by arranging conductive patterns at a distance from each other in a dielectric structure of the antenna apparatus.

An antenna radiator may be implemented on an M1 pattern among the layers constituting the antenna apparatus 500. The M1 pattern may include a resonator (e.g., 210 in FIG. 2), at least one pad (e.g., 230a in FIG. 2), at least one varactor 530, at least one ground line, and at least one bias line.

The bias line may include a conductor arranged in one direction of the M1 pattern from the resonator (e.g., 210 in FIG. 2) and may include a structure connected through a via 540 connected to one surface of the conductor arranged on the M1 pattern and to one surface of an M4 pattern. The via 540 may be arranged in a direction perpendicular to the conductor arranged in one direction of the M1 pattern.

The bias line may be connected to the center of the resonator (e.g., 210 in FIG. 2).

The ground line may include a conductor arranged in one direction of the M1 pattern from at least one pad (e.g., 230a in FIG. 2) and may include a structure connected through a via 550 connected to one surface of an M2 pattern. When the radiator includes a plurality of pads (e.g., 230a, 230b in FIG. 2), the ground line may be connected to the plurality of pads and each ground line may be arranged in the same direction. The ground line may be arranged in the same direction as the bias line.

The transmission line 510 may be implemented on an M3 pattern among the layers constituting the antenna apparatus 500.

A slot 520 may be implemented on the M2 pattern among the layers constituting the antenna apparatus 500. The slot 520 may be implemented on the M2 pattern by etching the ground plane of the M2 pattern. The slot 520 may connect the transmission line 510 implemented on the M3 pattern and the antenna radiator implemented on the M1 pattern, in a coupling form. The slot 520 may be arranged perpendicular to the direction of the transmission line 510.

The resonance frequency may be determined by the width between the conductor patterns. The resonance frequency of the antenna apparatus may be determined by adjusting the widths of the M1 pattern and the M2 pattern while maintaining the area of the resonator.

The M1 pattern of the antenna apparatus may be arranged at a position spaced apart from the M4 pattern by a distance less than the wavelength of the resonance frequency of the antenna apparatus, such as half the wavelength of the antenna resonance frequency. The M3 pattern may extend in parallel to the M1 pattern and may be shorter than the M1 pattern. The interval between the M2 pattern and the M3 pattern and the ground M4 pattern corresponding thereto may be less than or equal to the interval between the M1 pattern and the ground M4 pattern corresponding thereto. The interval between the M2 pattern and the M3 pattern may be equal to the interval from the M3 pattern and the ground M4 pattern corresponding thereto. The height between the M2 pattern and the M3 pattern and the interval from the M3 pattern and the ground M4 pattern corresponding thereto may be set to be about 0.1 mm to about 1.5 mm.

The M2 pattern may be arranged at a position spaced apart from the M1 pattern by a distance equal to a quarter of the wavelength of the resonance frequency of the antenna apparatus.

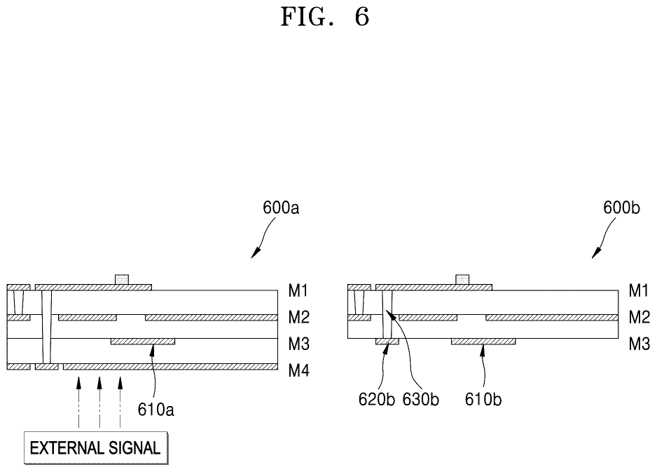

FIG. 6 illustrates a stack for each transmission line type of an antenna apparatus according to an embodiment.

Referring to FIG. 6, the antenna apparatus may include a stripline 610a coupled to an M4 pattern. For example, when the antenna apparatus requires an external signal blocking function, the antenna apparatus 600a may include a stripline 610a.

A stripline feed slot array antenna apparatus 600a may include an M3 pattern including a film-type dielectric with a stripline 610a formed thereon, an M4 pattern formed under the film-type dielectric to electrically isolate a plurality of transmission lines from each other, an M2 pattern formed over the film-type dielectric to electrically isolate the transmission lines from each other together with the M4 pattern, and an M1 pattern that radiates energy applied through the transmission line, as a radio wave to the outside.

As for the stripline 610a, because the transmission line is wired in the antenna apparatus, the upper surface and lower surface thereof may include a ground plane with respect to the transmission line. In this case, the effective relative dielectric constant may be equal to the relative dielectric constant of the dielectric substrate.

The antenna apparatus may have an open structure without an M4 pattern, and the transmission line may include a microstrip line 610b located on one surface of the antenna apparatus 600b. For example, when the antenna apparatus does not require an external signal blocking function, the antenna apparatus 600b may include a microstrip line 610b.

A microstrip feed slot array antenna apparatus 600b may include an M3 pattern including a film-type dielectric with a microstrip line 610b formed thereon, an M2 pattern formed over the film-type dielectric to electrically isolate the transmission lines from each other, and an M1 pattern that radiates energy applied through the transmission line, as a radio wave to the outside.

A microstrip feed slot array antenna apparatus 600b may be wired with an M3 pattern transmission line 610b and may form another ground layer 620b that is different from an M3 pattern transmission line. A bias line may be configured through a via 630b or the like that connects the M1 pattern and a conductor that is not a transmission line 610b as the M3 pattern.

By arranging a transmission line using a microstrip 610b, the implementation or arrangement of the antenna apparatus may be facilitated even in a narrow space. Since a transmission line (or radiation conductor pattern) may be formed on a plate through a printing, plating, deposition, or laser direct structuring (LDS) process, the degree of freedom of design in the shape or position of the transmission line (or radiation conductor pattern) may be improved. In this case, the effective relative dielectric constant may be determined by ((εᵣ+1)/2) as the arithmetic average of the relative dielectric constant of the dielectric substrate and the relative dielectric constant of free space.

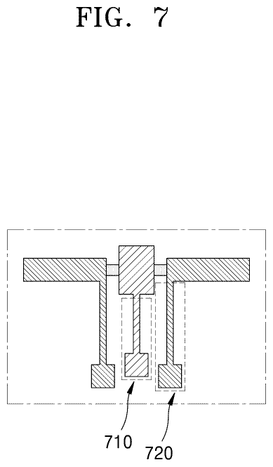

FIG. 7 illustrates a configuration of a bias line and a ground line according to an embodiment.

Referring to FIG. 7, a bias line 710 may include a direct current (DC) bias line for supplying a DC voltage and to supply a DC signal to a radiator. In a stripline (e.g., 610a of FIG. 6), the DC bias line may provide a positive or negative voltage to a resonator (e.g., 412 of FIG. 4A) through a via (e.g., 540 of FIG. 5) path including an M1 pattern and an M4 pattern including a resonator (e.g., 412 of FIG. 4A), a varactor (e.g., 220a of FIG. 2), and a pad (e.g., 230a of FIG. 2). The DC bias line may be connected to the center of the resonator (e.g., 412 of FIG. 4A). The length of the DC bias line arranged on the M1 pattern may be less than λ_{g}/2.

A ground line 720 may provide a ground connection for a DC voltage provided by the bias line 710 through a similar path through an M2 pattern in a via and a dielectric layer. The ground line 720 may be connected to a plurality of pads (e.g., 230a, 230b of FIG. 2).

In the ground line 720, to minimize the interference between adjacent antennas, a line connected through an M2 ground plane and a via (e.g., 550 of FIG. 5) may be configured to have a length of λ_{g}/4 to separate a radio frequency (RF) signal and a DC signal. By configuring the ground line 720 to have a length of λ_{g}/4, a circuit may be configured to perform an open circuit function based on the RF signal to prevent the RF signal from being transmitted to the radiator. As a circuit configuration for fixing the length of the ground line 720 to λ_{g}/4, an antenna circuit configuration separately using a DC block capacitor and an RF choke inductor generally used to separate an RF signal and a DC bias signal may not be used.

By applying a DC voltage to the resonator (e.g., 210 of FIG. 2) and simultaneously connecting the pad (e.g., 230a of FIG. 2) to the ground, the anodes of a plurality of varactor diodes (e.g., 220a, 220b of FIG. 2) may form a DC bias loop. The antenna apparatus may change the capacitance of the varactor (e.g., 220a of FIG. 2) of the antenna by controlling the voltage difference applied to the varactor (e.g., 220a of FIG. 2) by the voltage applied to the resonator (e.g., 210 of FIG. 2) and the pad (e.g., 230a of FIG. 2), thereby randomly varying the resonance frequency, impedance, polarization, and radiation pattern.

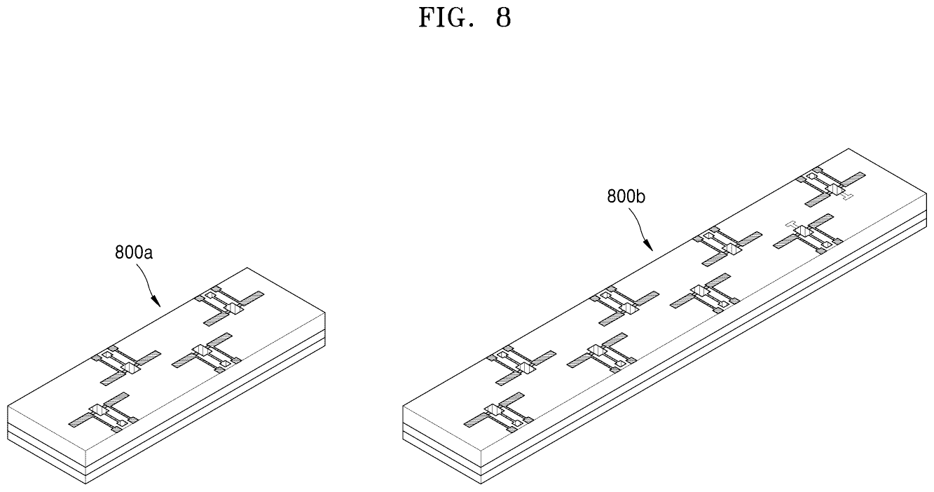

FIG. 8 illustrates a layout of antenna radiators according to an embodiment.

Referring to FIGS. 8, 800a and 800b illustrate embodiments of a serial feed antenna depending on the number of radiators. A phased array antenna may steer a signal radiated by an antenna, by controlling the phase and/or amplitude of a signal supplied to each of a plurality of radiators spaced at certain intervals. Thus, beam steering performed in a direction in which the highest performance may be ensured. The beamwidth may refer to an angle range in which a main lobe radiates energy. The size of the antenna array may increase as the number of radiators radiating electromagnetic waves increases. However, a signal received from a feed line may be radiated and a desired radar beam pattern may be formed through signals radiated by a plurality of radiators. Accordingly, because energy may be concentrated and radiated in a particular direction, the beamwidth may be reduced.

The radiators may be arranged by considering the number of antenna radiators according to the beamwidth desired by the user. In 800a, when a 35-degree beamwidth is required, four antenna radiators may be arranged in a triangular array-based form. In 800b, when a 15-degree beamwidth is required, eight antenna radiators may be arranged in a triangular array-based form.

FIG. 8 illustrates a structure in which four radiators or eight radiators are arranged in a triangular array-based form; however, this is merely an example and the disclosure is not limited thereto.

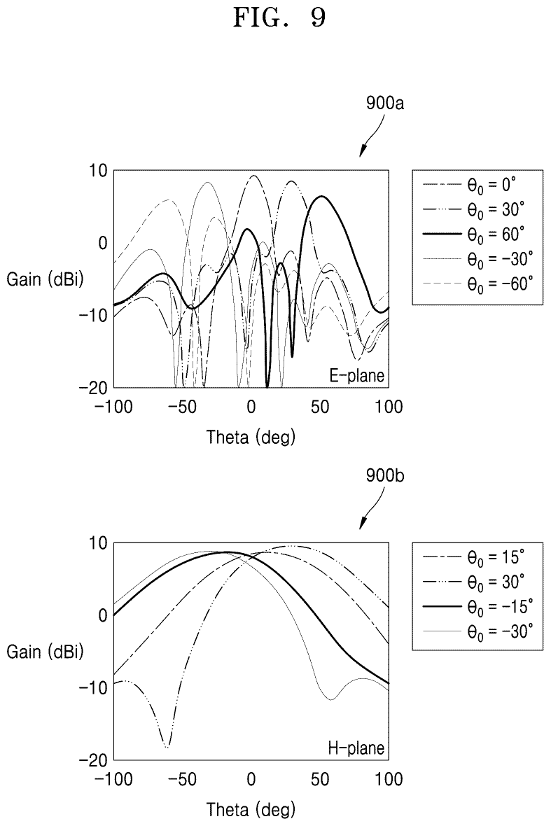

FIG. 9 illustrates a graph of a radiation pattern of a triangular array-based radiator according to an embodiment.

Referring to FIG. 9, when radiators are arranged based on a triangular array, two-dimensional beam steering may be performed by expanding the antenna array two-dimensionally not one-dimensionally. For example, by arranging antennas two-dimensionally, the antenna apparatus may independently steer beams in the longitudinal direction and the transverse direction. Signals may be individually controlled through each radiator and varactor, and dynamic beamforming may be achieved by controlling the beams in the longitudinal direction and the transverse direction.

Graphs 900a and 900b of FIG. 9 illustrate the radiation patterns of a reconfigurable triangular array serial feed antenna structure implemented when a bias is applied to the varactor according to a phase compensation method. Graph 900a shows a radiation pattern in an axis of the same direction as the transmission line, that is, in a plane (E-plane) including the electric field of a radio wave radiated from a radiator, and 900b shows a radiation pattern in an axis perpendicular to the transmission line, that is, in a plane (H-plane) including the magnetic field of the radiated radio wave. By configuring a varactor-based serial feed antenna in a triangular array, the two-dimensional precise beamforming performance may be implemented without reducing the antenna efficiency. The radiation pattern may be determined by the number of antenna radiators, the horizontal-axis spacing distance, and the inter-radiator distance represented as λ_{g}/2, and the radiation pattern AF(θ, φ) may be determined by Equation (2) below.

$$A F ( θ , φ ) = {\sum }_{n}^{f} {\sum }_{m}^{g} {I}_{n m} {e}^{j {φ}_{n m}} {e}^{j β ( 2 nΔX sin θ cos φ + m Δ Y sin θ sin φ )} + {\sum }_{n}^{f} {\sum }_{m}^{g} {I}_{n m} {e}^{j {φ}_{n m}} {e}^{j β ( ( 2 n Δ X + ΔX ) sin θ cos φ + ( m Δ Y + \frac{Δ Y}{2} ) sin θ sin φ )} , \qquad ( 2 )$$

$$f = \frac{N}{2} - 1 Where N = even , f = \frac{N - 1}{2} - 1 Where N = odd , g = M - 1$$

In Equation (2), φ is the phase of the varactor antenna, I is the signal strength of the varactor antenna, β is the phase constant 2(2π/λ₀), N is the number of radiators with respect to the plane (H-plane) including the magnetic field of the radiated radio wave, and M is the number of radiators with respect to the plane (E-plane) including the electric field of the radio wave radiated from the radiator.

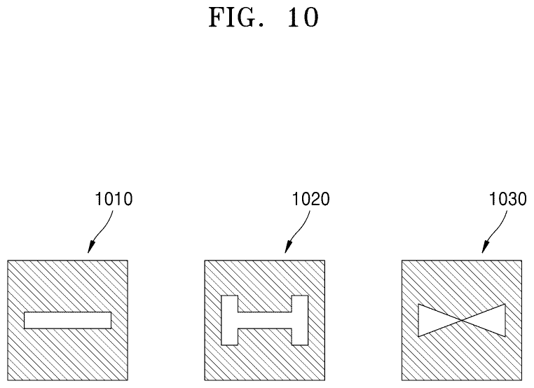

FIG. 10 illustrates a shape configuration of a slot according to an embodiment.

Referring to FIG. 10, the radiator (e.g., 200 of FIG. 2) may implement various resonance frequencies depending on the shape of the slot (e.g., 414 of FIG. 4A). Even when the shape of the radiator (e.g., 220a of FIG. 2) is the same, when the shape of the slot (e.g., 414 of FIG. 4A) is different, the resonance frequency may be different because the electrical environment around the slot (e.g., 414 of FIG. 4A) changes to affect the speed of a radio wave and the effective dielectric constant. For example, when the width of the slot (e.g., 414 of FIG. 4A) increases, the electric field may be distributed over a wider area and thus the effective dielectric constant may decrease and the resonance frequency may increase. When the slot (e.g., 414 of FIG. 4A) has a curved or complex shape, the effective length of the slot may increase and thus the resonance frequency may decrease. By implementing various resonance frequencies, the radiation bandwidth, gain, and efficiency of the antenna may be improved.

The length of the slot (e.g., 414 of FIG. 4A) may be set such that the slot radiates radio waves at one or more desired frequencies. The length of the slot (e.g., 414 of FIG. 4A) may be half the wavelength associated with the desired frequency. The antenna apparatus may include a plurality of slots, and one or more of the plurality of slots may be configured to operate as a radiation element for the antenna.

The shape of the slot (e.g., 414 of FIG. 4A) may be modified into a structure in which the horizontal length is greater than the vertical length, and may be modified into a structure that is horizontally symmetrical. The slot may have a structure such as a straight line shape 1010, an H shape 1020, or a butterfly shape 1030. FIG. 10 illustrates a shape structure of the slot (e.g., 414 of FIG. 4A); however, this is merely an example and the disclosure is not limited thereto.

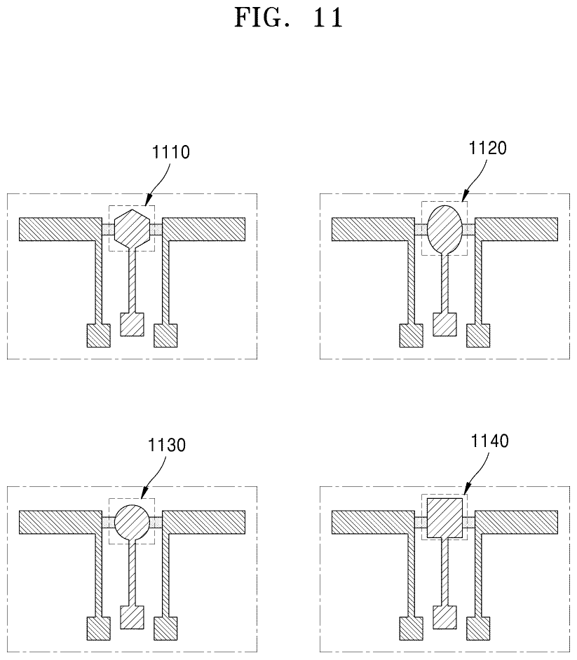

FIG. 11 illustrates a shape configuration of a resonator according to an embodiment.

Referring to FIG. 11, resonator (e.g., 210 of FIG. 2) accumulating and radiating energy at a particular frequency may affect the physical characteristics and operational characteristics of the resonator (e.g., 210 of FIG. 2). For example, when the resonator (e.g., 210 of FIG. 2) is a portion of the antenna, a change in the shape of the resonator (e.g., 210 of FIG. 2) may affect the radiation pattern. Particularly, as the shape becomes more complex, the length of a path through which an electromagnetic wave passes through the inside of the resonator may increase and thus the phase of a signal may be delayed. As such, the resonator shape (i.e., the shape of the resonator (e.g., 210 of FIG. 2)) may affect the radiation performance of the antenna and change the shape of the slot (e.g., 414 of FIG. 4A), thereby improving the bandwidth, gain, and efficiency.

The resonator (e.g., 210 of FIG. 2) may have a symmetrical shape. When the resonator (e.g., 210 of FIG. 2) has a symmetrical shape, a unidirectional current distribution may be induced and thus a directional pattern directed toward the upper portion of the resonator (e.g., 210 of FIG. 2) may be generated. The resonator shape (i.e., the shape of the resonator (e.g., 210 of FIG. 2)) may be vertically symmetrical and horizontally symmetrical. The resonator shape of the antenna radiator may have a hexagonal structure 1110, an elliptical structure 1120, a circular structure 1130, or a rectangular structure 1140. FIG. 11 illustrates a shape structure of the resonator (e.g., 210 of FIG. 2); however, this is merely an example and the disclosure is not limited thereto.

An antenna apparatus may include an antenna structure including a plurality of radiators, a transmission line, and a slot, wherein the antenna structure may include a first radiator, a second radiator, and a third radiator, the first radiator and the second radiator may be arranged in parallel in a direction parallel to the transmission line, and the third radiator may be arranged opposite the first radiator and the second radiator with respect to the transmission line to be arranged in a triangular form.

As described above, the radiator may include a resonator.

The radiator may include a first varactor connected to a first side of the resonator.

The radiator may include a second varactor connected to a second side of the resonator.

The radiator may include a first pad connected to the first varactor.

The radiator may include a second pad connected to the second varactor.

The resonator may be vertically symmetrical and horizontally symmetrical.

The first radiator and the third radiator, and the second radiator and the third radiator, may be spaced apart from each other by half a wavelength of an operation frequency with respect to an axis parallel to the transmission line.

The first radiator, the second radiator, and the third radiator may be spaced apart from each other by less than half a wavelength of an operation frequency with respect to an axis perpendicular to the transmission line.

A number of the plurality of radiators may be inversely proportional to a beam width.

The antenna apparatus may include a DC bias line.

The antenna apparatus may include a ground line.

The DC bias line may be connected to a center of the resonator.

The ground line may be connected to at least one of the first pad or the second pad.

The DC bias line may include a length less than half a wavelength of an operation frequency.

The ground line may include a length equal to a quarter of a wavelength of an operation frequency.

A shape of the slot may be horizontally symmetrical.

At least a portion of the slot may be located between the antenna structure and the transmission line.

A lower surface of the antenna apparatus may be arranged as a ground plane.

An electronic apparatus may include an antenna apparatus, wherein the antenna apparatus may include an antenna structure including a plurality of radiators, a transmission line, and a slot, wherein the antenna structure may include a first radiator, a second radiator, and a third radiator, the first radiator and the second radiator may be arranged in parallel in a direction parallel to the transmission line, and the third radiator may be arranged opposite the first radiator and the second radiator with respect to the transmission line to be arranged in a triangular form.

In the electronic apparatus, the radiator may include a resonator, a first varactor connected to a first side of the resonator, a second varactor connected to a second side of the resonator, a first pad connected to the first varactor, and a second pad connected to the second varactor.

In the electronic apparatus, the resonator may be vertically symmetrical and horizontally symmetrical.

In the electronic apparatus, the first radiator and the third radiator may be and the second radiator and the third radiator may be spaced apart from each other by half a wavelength of an operation frequency with respect to an axis parallel to the transmission line.

In the electronic apparatus, the first radiator, the second radiator, and the third radiator may be spaced apart from each other by less than half a wavelength of an operation frequency with respect to an axis perpendicular to the transmission line.

In the electronic apparatus, a number of the plurality of radiators may be inversely proportional to a beam width.

The antenna apparatus may include a direct current (DC) bias line, and a ground line.

In the electronic apparatus, the DC bias line may be connected to a center of the resonator.

In the electronic apparatus, the ground line may be connected to at least one of the first pad or the second pad.

In the electronic apparatus, the DC bias line may include a length less than half a wavelength of an operation frequency.

In the electronic apparatus, the ground line may include a length equal to a quarter of a wavelength of an operation frequency.

In the electronic apparatus, a shape of the slot may be horizontally symmetrical.

In the electronic apparatus, at least a portion of the slot may be located between the antenna structure and the transmission line.

In the electronic apparatus, a lower surface of the antenna apparatus may be arranged as a ground plane.

The components included in the disclosure are expressed as singular or plural depending on particular embodiments presented herein. However, the singular or plural expression is selected suitably for the presented situation for convenience of description, and the disclosure is not limited to singular or plural components; for example, components expressed as plural may include singular components, or components expressed as singular may include plural components.

While particular embodiments of the disclosure have described above in detail, it should be understood that various modifications may be made therein without departing from the scope of the disclosure. For example, some or all of some embodiments may be combined with some or all of one or more other embodiments, and such combinations may naturally fall within the scope of the disclosure. Therefore, the scope of the disclosure should not be limited to the described embodiments

Herein, the antenna array of the antenna apparatus may form a triangular array, thus solving the beamforming performance and efficiency problem of the antenna apparatus and the electronic apparatus.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. An antenna apparatus comprising:
an antenna structure comprising a plurality of radiators including a first radiator, a second radiator, and a third radiator;
a transmission line; and
a plurality of slots,
wherein the first radiator and the second radiator are arranged in parallel in a direction parallel to the transmission line, and
wherein the third radiator is arranged opposite the first radiator and the second radiator with respect to the transmission line to be arranged in a triangular form.

2. The antenna apparatus of claim 1, wherein each of the plurality of radiators comprises:
a resonator;
a first varactor connected to a first side of the resonator;
a second varactor connected to a second side of the resonator;
a first pad connected to the first varactor; and
a second pad connected to the second varactor.

3. The antenna apparatus of claim 2,
wherein a shape of the resonator is vertically symmetrical and horizontally symmetrical.

4. The antenna apparatus of claim 1,
wherein the first radiator and the third radiator are and the second radiator and the third radiator are spaced apart from each other by half a wavelength of an operation frequency with respect to an axis parallel to the transmission line.

5. The antenna apparatus of claim 1,
wherein the first radiator, the second radiator, and the third radiator are spaced apart from each other by less than half a wavelength of an operation frequency with respect to an axis perpendicular to the transmission line.

6. The antenna apparatus of claim 1,
wherein a number of the plurality of radiators is inversely proportional to a beam width.

7. The antenna apparatus of claim 2, further comprising:
a direct current (DC) bias line; and
a ground line,
wherein the DC bias line is connected to a center of the resonator, and
wherein the ground line is connected to at least one of the first pad or the second pad.

8. The antenna apparatus of claim 7,
wherein the DC bias line includes a length less than half a wavelength of an operation frequency, and
wherein the ground line includes a length equal to a quarter of a wavelength of an operation frequency.

9. The antenna apparatus of claim 1,
wherein a shape of each slot is horizontally symmetrical, and
wherein at least a portion of each slot is located between the antenna structure and the transmission line.

10. The antenna apparatus of claim 1,
wherein a lower surface of the antenna apparatus is arranged as a ground plane.

11. An electronic apparatus comprising an antenna apparatus,
wherein the antenna apparatus comprises:
an antenna structure comprising a plurality of radiators including a first radiator, a second radiator, and a third radiator;
a transmission line; and
a plurality of slots,
wherein the first radiator and the second radiator are arranged in parallel in a direction parallel to the transmission line, and
wherein the third radiator is arranged opposite the first radiator and the second radiator with respect to the transmission line to be arranged in a triangular form.

12. The electronic apparatus of claim 11, wherein each of the plurality of radiators comprises:
a resonator;
a first varactor connected to a first side of the resonator;
a second varactor connected to a second side of the resonator;
a first pad connected to the first varactor; and
a second pad connected to the second varactor.

13. The electronic apparatus of claim 12,
wherein the resonator comprises a figure that is vertically symmetrical and horizontally symmetrical.

14. The electronic apparatus of claim 11,
wherein the first radiator and the third radiator, and the second radiator and the third radiator, are spaced apart from each other by half a wavelength of an operation frequency with respect to an axis parallel to the transmission line.

15. The electronic apparatus of claim 11,
wherein the first radiator, the second radiator, and the third radiator are spaced apart from each other by less than half a wavelength of an operation frequency with respect to an axis perpendicular to the transmission line.

16. The electronic apparatus of claim 11,
wherein a number of the plurality of radiators is inversely proportional to a beam width.

17. The electronic apparatus of claim 12, wherein the antenna apparatus further comprises:
a direct current (DC) bias line; and
a ground line,
wherein the DC bias line is connected to a center of the resonator, and
wherein the ground line is connected to at least one of the first pad or the second pad.

18. The electronic apparatus of claim 17,
wherein the DC bias line includes a length less than half a wavelength of an operation frequency, and
wherein the ground line includes a length equal to a quarter of a wavelength of an operation frequency.

19. The electronic apparatus of claim 11,
wherein a shape of each slot is horizontally symmetrical, and
wherein at least a portion of each slot is located between the antenna structure and the transmission line.

20. The electronic apparatus of claim 11,
wherein a lower surface of the antenna apparatus is arranged as a ground plane.
